(19) United States
(12) Patent Application Publication
(10) Pub. No.: US 2010/0307847 A1
(43) Pub. Date: Dec. 9, 2010

(54) Compressed Air Powered Electric Drive Vehicle

(76) Inventors: Justine Lungu, Hillsborough, CA (US); John V. Zambrzycki, Redwood City, CA (US)

Correspondence Address: John Zambrzycki, 1123 King Street, Redwood City, CA, 94061, US

(21) Appl. No.: 12/479,789

(22) Filed: Jun. 6, 2009

(51) Int. Cl. B60L 11/00; F15B 11/10; H01M 8/00; H01M 6/00; B60L 11/18; B60L 11/02; B60L 11/16

(52) U.S. Cl. 180/65.31; 60/407; 429/122; 307/10.1; 429/400

(57) ABSTRACT

This disclosure describes an electric drive ground transportation vehicle, comprising a first energy storage subsystem and at least one other energy storage subsystem, at least one energy regeneration subsystem, at least one energy management controller, wherein said controller controls the routing of energy between the vehicle's subsystems based on the status, capabilities, and demands of the various subsystems, and the requirements imposed on the vehicle, and said at least one energy regeneration subsystem can regenerate energy in said first energy storage subsystem and/or said at least one other energy storage subsystem while the vehicle is in operation.

### TECHNICAL FIELD

This invention relates to ground transportation vehicles, in particular vehicles wherein the operating energy is derived from sources other than internal combustion engines, and wherein the drive mechanisms are powered directly via electric motors.

### BACKGROUND OF THE INVENTION

In the early days of the automobile, steam, electricity and gasoline competed as the energy source of choice. Today, the internal combustion engine reigns supreme, with electricity powering some buses and light-rail trains (via direct connections to power grids), or very small vehicles (e.g., golf carts) with limited range and duration, and steam long gone. And as before, the energy in the majority of instances is still transmitted via mechanical transference to the wheels from the engine/motor through various gearing and other mechanical couplings. Thus, two separate problems exist: the limited choice of energy sources, and the mechanisms available to convert stored energy into locomotion.

The current invention addresses both problems directly. In the first, the invention allows for multiple energy sources which can be used simultaneously or singularly. In the second, the invention reduces the mechanical complexity of current ground transportation vehicles by allowing for direct electric drive.

### The Internal Combustion Engine

Petrochemical powered transportation vehicles offer a singular benefit, and a singular burden: the fuel source has a very high energy density, but the stock for this fuel source is rapidly diminishing. Although the engines are not greatly efficient, the energy source (gasoline, diesel, etc.) has a high enough energy density to allow significant travel distances without refueling. Additionally, the last hundred years have seen the development of a vast support network of fuel transit pipelines, refineries, and end-user distribution points. It is this network effect that makes the current petrochemical system so useful, and what makes creating a new primary fuel source so difficult.

But the days of petrochemical fuels are numbered. These fossil fuels were created from material laid down hundreds of millions of years ago, and the stock for this fuel will not be regenerated. As more nations develop their economies, new users for these limited resources are created, adding further strain on the supply. Eventually, no matter the improvements in efficiency of the engines, the supply will run out. And if this were not enough, it has come to be believed that the use of these fossil fuel sources has changed the chemical composition of the very air, adding “greenhouse gases” and altering the weather of our planet.

One current proposal is to begin a transition to natural gas, another fossil fuel, instead of gasoline or diesel, but the same laws of supply and demand, and the same damage to the environment will eventually repeat. Another proposal is to create a new fuel source similar to petrochemicals, so-called bio-fuels, which will still work with traditional internal combustion engines. But these fuel sources do not carry the same energy density as traditional fuels, and there is great debate as to whether the manufacture (growing), processing, distribution and use of these as fuels is actually environmentally positive. And again, the continued use of localized combustion for generating energy is still saddled with the problem of having to deal with the pollution created by millions of point sources.

Various solutions to these problems, particularly the use of alternative fuel types, have been brought to the public, with very little resonance. For example, some have argued that cars should run only on electricity—and today some cars do. These all-electric cars are powered by batteries. However, the battery technology available today poses two insurmountable hurdles: limited driving distance (due to limited energy density of the batteries), and long recharge times.

One solution offered to these problems has been to create hybrid-electric systems, where the electric power has been supplemented by a traditional internal combustion engine. Some systems currently in use are parallel (either one or both of the engines can be used at the same time), or serial (where the internal combustion engine is used only to generate electricity). But as before, even these hybrids can not avoid the fate of all engines that require fossil fuels.

More esoteric means of powering vehicles have been proposed: fuel cell vehicles, direct hydrogen powered vehicles, solar powered vehicles, etc. But each of these, although avoided fossil fuels, still suffer from other technical and technological problems which prohibit wide adoption. For example, fuel cells offer an elegant and clean method of generating electricity—but the storage of the fuel source has proven problematic, as has achieving a high enough level of efficiency and redundancy to be viable. Hydrogen power would seem to be ideal—but the extraction, transmission, and storage of either liquid or gaseous hydrogen, especially the storage under pressure in a vehicle, has proven both difficult and potentially dangerous. And of course, solar power, while being very simple and straightforward, does not currently allow for the generation of enough power to robustly operate a vehicle for long periods of time, especially if the weather does not cooperate.

Thus, there is a need in the art for a vehicle wherein:
the on-board fuel source(s) contain enough energy to power the vehicle at least as robustly, in terms of both range and performance, as today's petrochemical engines,
the creation, transport, and storage, of the fuel source(s) poses no danger,
the operation of the vehicle produces no pollution,
wherein the energy source(s) can be regenerated while the vehicle is in operation, and
the energy source(s) can be refilled, recharged, or replenished en toto, in at least the same amount of time that it would take to refill, recharge, or replenish an existing petrochemical powered car (that is, fill a tank with petrol).

### Prior Art Limitations

The internal combustion engine is a masterpiece of engineering. Fuel is injected into an internal cavity, mixed with air, pressurized, and combusted, resulting in a force which drives a piston. Many different forms of rotary and orbital engines as well as other forms of engines have been proposed in the past with varying degrees of success to replace the traditional piston-style engine, but overall there has been no serious challenge to the reciprocating internal combustion engine at least insofar as automobiles are concerned. This fact is primarily due to the high wear rate in rotary engines and possibly the fact that the improvements in efficiency of rotary engines over reciprocating engines has not been sufficient to justify a major change in direction for engine manufacturers.

But regardless of the type, internal combustion engines have limitations as far as total energy efficiency. Inefficiencies in converting chemical potential energy into thermal energy (combustion), and then the conversion from thermal into kinetic energy (the expansion of the combustion products), and then the transmission of this kinetic energy through multiple mechanical linkages, severely limit the percentage energy that actually reaches the tire.

Electric drive systems offer a tremendous improvement in overall efficiencies by eliminating several mechanical linkages. But the storage of a large enough amounts of electricity require an inordinate amount of batteries, which causes a commensurate increase in weight—nearly offsetting the efficiency savings generated by eliminating the mechanical linkages in the first place. Worse, the battery packs still suffer from chemical deficiencies in the ability to be quickly and fully recharged, limitations in the amount of energy that can be drawn off (both constant and surge loads), and the number of times they can be recharged. Worse, the better battery technologies require the use of exotic materials or heavy metals, which pose their own environmental issues. Even with new and improved battery technologies, these problems will not be overcome any time soon.

Thus, what is required is a means for generating electricity on a nearly continuous basis wherein:
the amount of energy generated can be varied to meet the load required,
the generation of the electricity does not cause localized pollution,
the electricity storage system does not require an excessive use of exotic materials, heavy metals, or toxic substances, and
the electricity storage system can be recycled within available technologies.

Thus, it is an object of this invention to provide an alternative means for powering ground transportation vehicles which eliminates reliance on internal combustion, resolves issues with battery technologies, enables the vehicle to operate in a non-polluting manner, which can be charged and recharged, quickly, and which can be recharged while the vehicle is in operation.

### SUMMARY OF THE INVENTION

The invention comprises several general aspects, each of which can, if desired, be combined with additional features, including features disclosed and/or not disclosed herein, resulting in combinations representing more detailed optional embodiments of these aspects.

In a first aspect of the invention, there is provided an electric drive ground transportation vehicle, comprising a first energy storage system, at least one other energy storage system, at least one energy regeneration system, at least one energy management controller, and at least one electric motor, wherein the energy storage systems deliver electrical energy to said at least one electric motor (s), wherein said controller controls the routing of energy between the vehicle's systems based on the status, capabilities, and demands of the various systems, and the requirements imposed on the vehicle, and wherein said at least one energy regeneration subsystem can regenerate energy in said first energy storage system and/or said at least one other energy storage system while the vehicle is in operation.

In various embodiments of this first aspect, said first energy storage system may comprise a vessel containing a gas under pressure, batteries, ultra capacitors or fuel cells. Said first and said at least one other energy storage systems may store energy in a similar form or may store energy in different forms. The different forms may include a vessel containing a gas under pressure (including air, or molecular or atomic gases, e.g., hydrogen), batteries, ultra capacitors, fuel cells, fly wheels, etc.

In various forms of this embodiment, the potential energy of a gas under pressure may be converted into electrical energy. The conversion may use a turbine, an impeller, or an oscillating chamber. The conversion may take place without combustion.

In other embodiments, the electric motors(s) may be powered by energy supplied by a single energy storage system, without requiring the use of energy from some other source, or may be powered by multiple energy storage systems simultaneously.

In still other embodiments, the energy generated in one energy storage system may be used to replenish or increase the energy stored in another energy storage system. The replenishment or increase may be performed between the various energy storage systems while the vehicle is in motion, or while the vehicle is stationary. In addition, the vehicle, while stationary, may have its various energy storage systems replenished, or have the energy stored within increased, via connections made to external energy sources.

### ADVANTAGES OF THE INVENTION

The following discussion of advantages is not intended to limit the scope of the invention, or to suggest that every form of the invention will have all of the following advantages. As will be seen from the remainder of this disclosure, the present invention provides a variety of features. These can be used in different combinations. The different combinations are referred to as embodiments. Most embodiments will not include all of the disclosed features. Some simple embodiments can include a very limited selection of these features. Those embodiments may have only one or a few of the advantages described below. Other preferred embodiments will combine more of these features, and will reflect more of the following advantages. Particularly preferred embodiments, that incorporate many of these features, will have most if not all of these advantages. Moreover, additional advantages, not disclosed herein, that are inherent in certain embodiments of the invention, will become apparent to those who practice or carefully consider the invention.

The foregoing and other objects of the invention are achieved by using all-electric motors to drive the vehicle, and by using two or more energy storage systems, wherein the one or more of these energy storage systems may be replenished, or have the energy stored therein increased, while the vehicle is in motion.

In particular, a vehicle configured with such, using appropriate energy sources, can operate in a non-polluting fashion. When appropriately configured, the electric motor(s) driving the wheels can be converted to generate electricity when the car is breaking, or when travelling downhill. The excess energy produced can then be put back into the energy storage systems, extending the range of the vehicle.

A further advantage of an “all electric” design, that is, a design without direct mechanical connections between the energy sources and the wheels, is that it then becomes possible to create a fully plug-and-play component-based vehicle, wherein if a system becomes inoperable it can be by-passed or replaced without impact to any other system. Additionally, without the need for mechanical connections, the disparate systems can be located nearly anywhere in the vehicle body, enabling greater design freedom, and greater ease of access for repair or replacement.

The next advantage is that a vehicle with multiple energy sources has a built in redundancy, whereby energy can be sourced from one system or more depending on need and availability. Thus, a first system could be completely drained, or rendered inoperative, and the vehicle could still be operable.

The concept of having one of the energy sources being compressed air is yet a further advantage, in that it is possible to create a dump tank, wherein the compressed air tank on the car can be nearly instantaneously refilled, thus eliminating one of the major drawbacks of battery operated vehicles which can take several hours to recharge.

### BRIEF DESCRIPTION OF THE DRAWINGS

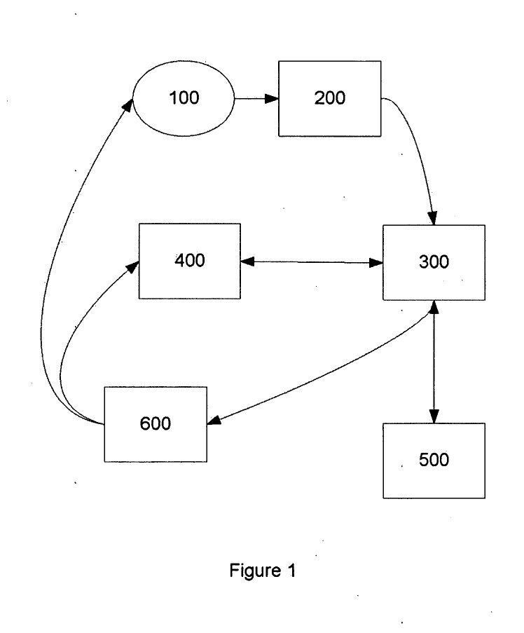

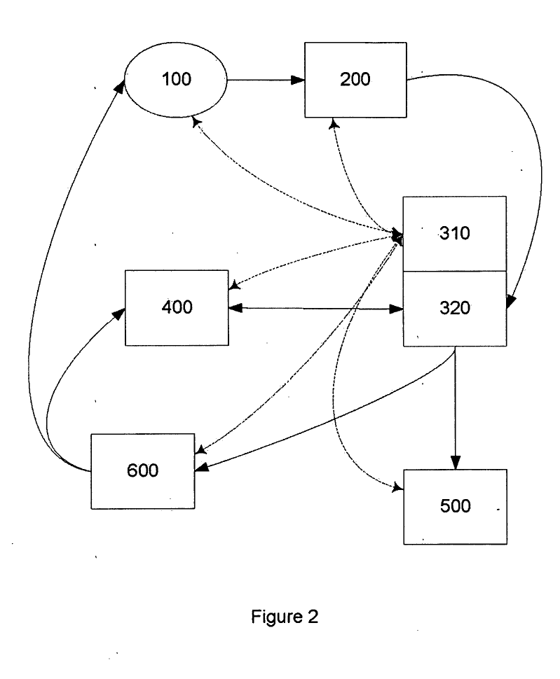

### FIGS. 1 and 2

### Basic System

FIG. 1 comprises a first energy storage system 100, an energy conversion device 200, an energy system management controller 300, at least one other energy storage system 400, an electric motor 500, and an energy regeneration system 600.

FIG. 2 is nearly identical to FIG. 1, replacing the energy system management controller 300 with a discrete energy management controller 310 and a discrete energy distribution node 320.

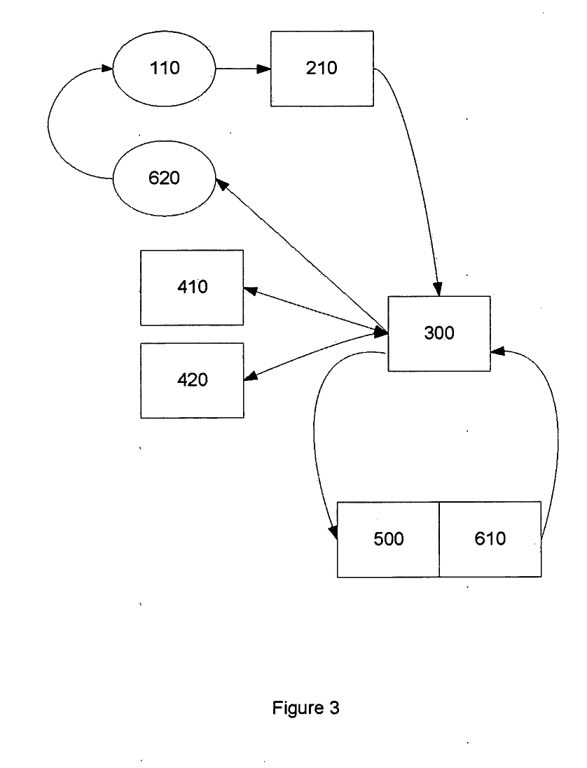

### FIGS. 3, 4, and 5

### Generic Embodiments

FIG. 3 comprises a compressed air storage vessel 110, a turbine-generator 210, an energy system management controller 300, a battery storage system 410, an ultra capacitor energy storage system 420, an electric motor 500, a brake regeneration system 610, and an air compressor 620.

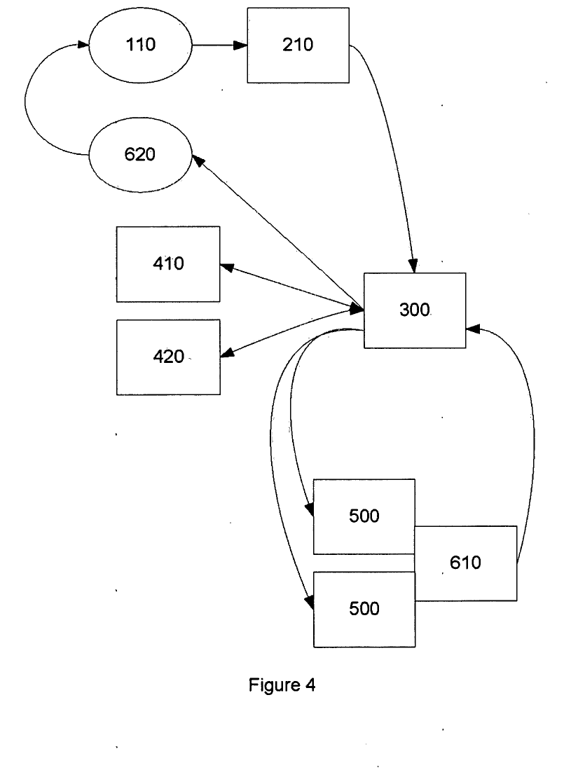

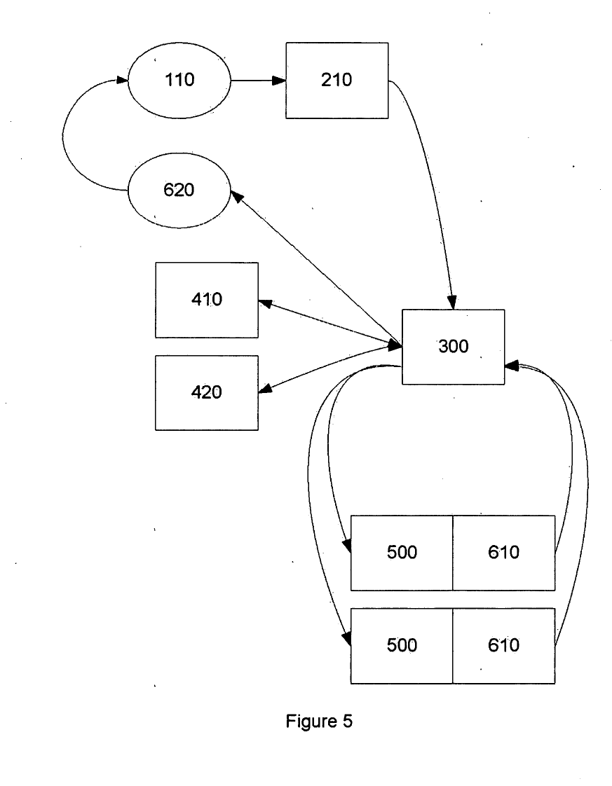

FIGS. 4 and 5 are variations on FIG. 3: FIG. 4 comprises multiple electric motors; FIG. 5 comprises multiple electric motors 500 and multiple brake regeneration systems 610.

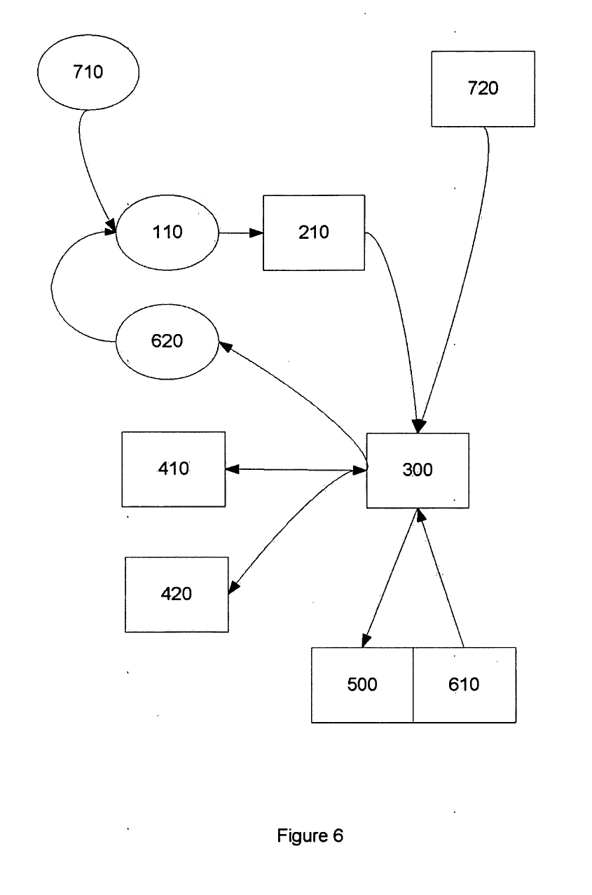

### FIG. 6

### External Energy Sources

FIG. 6 details an external compressed air source 710, and an external electrical source 720 to the base embodiment of FIG. 3.

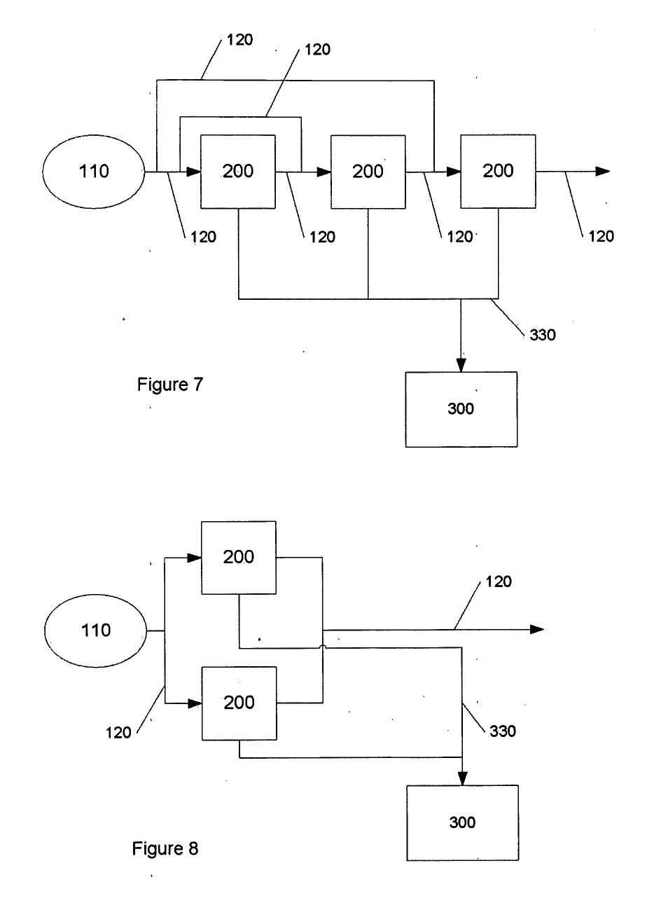

### FIGS. 7 and 8

### Multi-Staged Energy Conversion Device

FIGS. 7 and 8 comprise a compressed air storage vessel 110, compressed air flows 120, multiple energy conversion devices 200, electrical energy 330, and an energy system management controller 300.

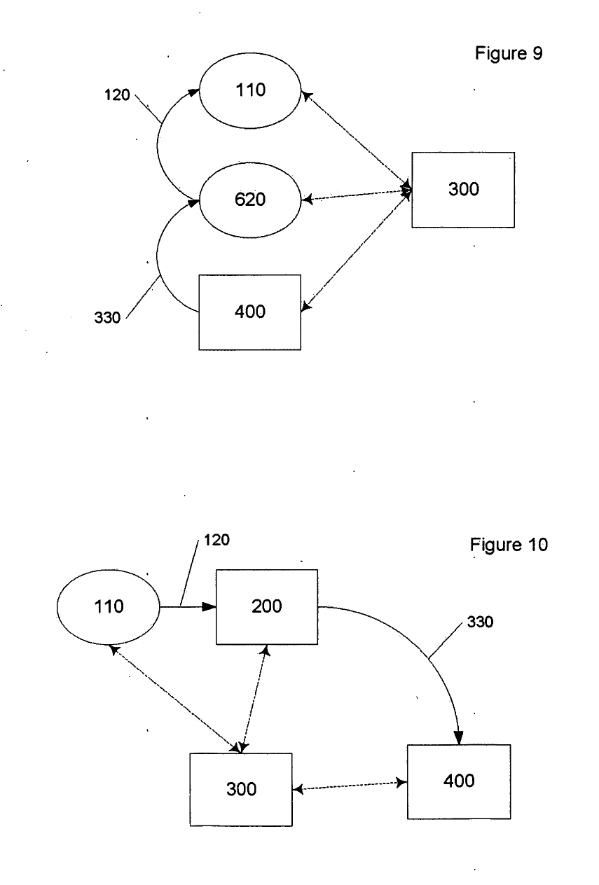

### FIG. 9

### Energy Input to a Compressed Air Storage System

FIG. 9 shows an energy storage system 400 transmitting electrical energy 330 to a compressor 620, as managed by the energy system management controller 300. The compressor 620 supplies compressed air 120 to the compressed air storage vessel 110.

### FIG. 10

### Energy Input to an Electrical Energy Storage System

FIG. 10 shows a compressed air storage vessel 110 supplying compressed air 120 to a turbine-generator 210, which transmits electrical energy 330 to an electrical energy storage system 400, as managed by the energy system management controller 300.

### FIG. 11

### Energy Capture via Regenerative Braking

FIG. 11 details a brake regeneration system 610 supplying electrical energy 330 to an electrical energy storage system 400, as managed by the energy system management controller 300.

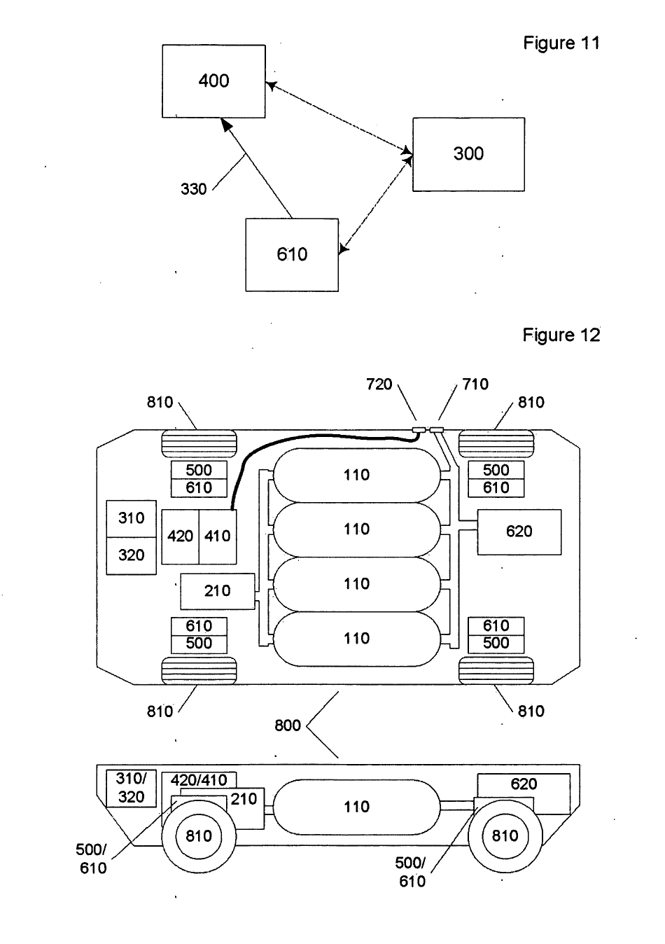

### FIG. 12

### Motor Vehicle Layout

FIG. 12 details a preferred embodiment as laid out in a typical motor vehicle chassis 800. In addition to the wheels 810, the system includes: a compressed air system (comprising multiple compressed air storage vessels 110, a turbine-generator 210, and a compressor 620), an electrical energy storage system (comprising a battery storage systems 410 and an ultra capacitor energy storage system 420), multiple electric motors 500 and brake regeneration systems 610, an energy management controller 310 and a energy distribution node 320. The chassis also shows connection points for an external compressed air source 710, and an external electrical source 720.

### DETAILED DESCRIPTION OF THE DRAWINGS

### FIGS. 1 and 2

### Basic System

FIG. 1 is a set of block diagrams detailing the layout of the major subsystems of a compressed air powered electric drive vehicle. Energy in a first medium is stored in energy storage device 100. The energy stored in this device can be replenished internally by the vehicle while in motion or at rest, and can be supplemented or replenished by external sources. In the most typical embodiment, this first medium is compressed air. As compressed air does not have a definitive shape, the shape of the storage device 100 can be made to conform to whatever limitations are required for best-fit location in the vehicle. Also, since compressed air will fill any set of vessels that are connected with equal pressure, multiple storage vessels can be used and treated as a single system, or can be discretely connected. The device 100 will nominally have at least one port with two taps, a first tap allowing compressed air into the vessel, and a second tap creating a controllable exit port leading to at least one energy conversion device 200. The release of air from the device 100 can be managed by measuring the released air's volume or pressure.

The compressed air then enters an energy conversion device 200 which converts the energy of the compressed air into electrical energy. Most typically, this device is a rotary turbine-generator 210. Other devices capable of converting the potential energy of the compressed air into electrical energy may be used in lieu of a turbine-generator, such as an oscillating cylinder, wherein a high pressure air from vessel 100 is alternately injected into opposite sides of the cylinder causing an internal piston to rapidly move back and forth, or an impeller-based system. The energy conversion device 200 may be a single-stage or a multi-stage, or may comprise multiple energy conversion devices chained in parallel or in series along the flow path of the compressed air.

The electrical energy generated by the energy conversion device 200 is then distributed to electric motor(s) and other systems and components within the vehicle, e.g., headlights, radio, air conditioner. The distribution of the electrical energy is managed by the energy system management controller 300. The energy system management controller 300 also manages the flow of electricity between the other storage system 400, and the energy regeneration system 600.

Energy may be drawn from or pushed to the other storage system 400, depending on its current storage capacity, and the required draw for supporting the operations of the vehicle. If excess energy is available, for example, if the motor 500 is acting in regenerative braking mode, the excess energy may be supplied to the other storage system 400 directly, or may be used to power an energy regeneration system 600 which converts the electrical energy into a form suitable for storage by the various energy storage systems 100 or 400.

In FIG. 2, the energy system management controller is shown decomposed into its constituent parts, shown as a discrete energy management controller 310, and a discrete energy distribution node 320. The controller 310 communicates (shown via dashed lines) with the various systems and subsystems to determine their state and their needs; the distribution node 320 regulates the flow of energy (solid lines) between the various systems as directed by the controller.

### FIGS. 3, 4, and 5

### Generic Embodiments

FIG. 3 shows a generic embodiment of the invention with a more detailed flow, and additional components. In this example, the primary energy storage is a compressed air storage vessel 110. The compressed air is transmitted to a turbine-generator (s) 210 which generates electricity for the electrical motor(s) 500 and the other systems and components of the vehicle.

A battery storage system 410, and an ultra capacitor storage system 420, are also electrically connected to and managed by the energy system management controller 300. The battery storage system 410 provides for larger storage capacity than the ultra capacitor storage system 420, but the ultra capacitors enable larger surge capacity in both charge (e.g., hard braking) and discharge (e.g., large scale acceleration while hauling a heavy load) that might damage a battery system.

The flow of electricity supplied to the motor(s) 500 is managed by the energy system management controller 300. Depending on the amount of electricity required by the motor(s), the energy management controller may draw the required power from the turbine-generator(s) 210, the battery system 410, the ultra capacitor system 420, or some combination of these systems.

A regenerative braking system(s) 610 can be positioned on the axel, at the wheels, or at the motor (s). Depending on the mode of operation, and the various loads and storage capacities of the energy storage systems, the energy produced may be sent to the ultra capacitors 420 or the battery system 410.

As the batteries 410 and/or ultra capacitors 420 reach their maximum storage potential, the energy system management controller 300 may direct the transfer of energy to the compressor 620, which converts the electrical energy into compressed air to be stored in the compressed air storage vessel 110.

### FIG. 6

### External Energy Sources

Depending on the nature of the energy storage systems, various external systems may be connected to the vehicle and used to replenish or increase the amount of energy stored. For example, if the primary energy storage system stores energy via compressed air 110, an external source of compressed air 710 may be used. The external source of compressed air 710 may be a large scale external compressor, or may be something as simple as a dump tank (a vessel pre-charged with a large volume of high-pressure air).

If the energy storage systems store energy via electrical energy, an external source of electrical energy 720 may be connected to the vehicle. The external source 720 may be AC or DC, and may have various voltage and/or current characteristics (e.g., 110 V @ 60 Hz, 220 V @ 50 Hz). The electrical energy may be stored directly in the electrical energy storage systems 410 or 420, or may be used, directly or indirectly, to power the compressor 620 and converted into compressed air stored in 110.

### FIGS. 7 and 8

### Multi-Staged Turbine-Generators

FIGS. 7 and 8 show the various arrangements available for connecting devices capable of generating electricity 330 from high pressure air 120. High pressure air 120 is stored in energy storage system 110 and released into energy converters 200. Several classes or types of devices 200 are available for converting the potential energy of high pressure air into electrical energy 330, including turbines, impellers, and oscillating cylinders. In FIG. 7, the energy converters 200 are connected in series; in FIG. 8, the energy converters 200 are connected in parallel. The electrical energy 330 generated is managed by the energy system management controller 300.

In FIG. 7, the highest pressure air leaves the storage vessel 110 and enters the first converter 200. As energy is extracted, the pressure drops, and the air at a slightly lower pressure enters the second converter, where the process repeats. In cases where the pressure in storage vessel 110 is no longer high enough to operate the first converter 200 efficiently, the system may be equipped with by-pass mechanisms to allow for compressed air to be shunted to the appropriate converter 200. Although shown as discrete systems, for the sake of clarity, the multi-stage approach outlined above could take place within a single device.

In FIG. 8, the high pressure air leaves the storage vessel 110 and enters one or more converters 200. Depending on the amount of energy required by the system, multiple converts may be operated simultaneously.

### FIG. 9

### Energy Input to a Compressed Air Storage System

FIG. 9 shows the ability of the system to convert electrical energy 330 into potential energy to be stored as compressed air 120 in storage vessel 110. Electrical energy 330 from an electrical energy storage system 400 is directed into the compressor 620 via the energy system management controller 300. The compressor compresses ambient air and stores it in storage vessel 110. The compressor can be operated while the vehicle is in motion, or while stationary. Additionally, the electrical energy 330 from storage system 400 may be supplemented or replaced by electrical energy from an external source 720, as shown in FIG. 6 when the vehicle is stationary.

### FIG. 10

### Energy Input to an Electrical Energy Storage System

FIG. 10 shows the ability of the system to convert the potential energy of compressed air 120 into electrical energy 330. Compressed air 120 is directed by the energy system management controller 300, through the energy converter 200, generating electrical energy 330 which is then stored in storage system 400. Energy can be directed into storage system 400 while the vehicle is stationary, or while in motion. Additionally, the compressed air 120 supplied by storage vessel 110 may be supplemented or replaced by compressed air from an external source 710, as shown in FIG. 6 when the vehicle is stationary.

### FIG. 11

### Energy Capture via Regenerative Braking

FIG. 8 details a brake regeneration system 620 supplying electrical energy 330 to an electrical energy storage system 400, as managed by the energy system management controller 300. The system can generate electrical energy while braking in standard mode (e.g., while slowing during traffic) or while travelling downhill.

### FIG. 12

### Motor Vehicle Layout

FIG. 12 shows the general position of the major components of the system as configured in the frame of a typical motor vehicle.

The compressed air system comprises multiple compressed air storage vessels 110 positioned side-by-side, connected to a common distribution system, which connects the compressed air to both the turbine-generator 210 and an internal compressor 620. The distribution system also connects to an access port for connecting to an external source of compressed air 710 from which to recharge the tanks. In one of the preferred embodiments, each tank in the set can be operated independently, allowing various combinations of serial or parallel operations, and more importantly, allowing the compressor to refill/recharge an empty tank while the other tanks continue operating the vehicle. Regardless of the operational configuration, each device (110, 210, and 620) can be configured with a regulator through which the pressure of the air accepted/released by the tanks and other devices can be controlled.

The electrical energy storage system (comprising a battery storage systems 410 and an ultra capacitor energy storage system 420), and the energy system management controller (energy management controller 310 and an energy distribution node 320) are shown, with the battery storage system 410 having an access port for connecting to an external source of electrical energy 720.

In this example, each wheel is shown to be driven by a separate motor 500, and each motor has a discrete brake regeneration system 610. Alternatively, a single electric motor 500 can be used to drive a common axel for the front wheels, the rear wheels, or connected via a differential, both axels. In another variation, independent motors are connected on separate front and rear axels. The brake regeneration system 610 can be located at the wheel, at the axel, or at the motor, and the number and location can be independent of the number and location of motors.

### OBJECT IDENTIFICATION NUMBERS

The following table identifies the objects labeled in the included drawings:

| | |
|---|---|
| 100 | First energy storage device |
| 110 | High pressure storage vessel |
| 120 | High pressure air |
| 200 | High pressure air/electrical energy |
| | converter |
| 210 | Turbine-generator |
| 300 | Energy system management controller |
| 310 | Energy management controller |
| 320 | Energy distribution node |
| 330 | Electrical energy |
| 400 | Second energy storage device |
| 410 | Battery storage system |
| 420 | Ultra capacity storage system |
| 500 | Electrical motor(s) |
| 600 | Energy regeneration system |
| 610 | Brake regeneration system |
| 620 | Compressor |
| 700 | External energy source |
| 710 | External compressed air source |
| 720 | External electrical source |
| 800 | Vehicle chassis |
| 810 | Wheels |

1. An electric drive ground transportation vehicle, comprising a first energy storage system, at least one other energy storage system, at least one energy regeneration system, at least one energy management controller, and at least one electric motor, wherein the energy storage systems deliver electrical energy to said at least one electric motor(s), wherein said controller controls the routing of energy between the vehicle's systems based on the status, capabilities, and demands of the various systems and the requirements imposed on the vehicle, and said at least one energy regeneration subsystem can regenerate energy in said first energy storage system and/or said at least one other energy storage system while the vehicle is in operation.

2. A device as in claim 1 wherein said first energy storage system comprises a vessel containing a gas under pressure.

3. A device as in claim 1 wherein said first energy storage system comprises batteries.

4. A device as in claim 1 wherein said first energy storage system comprises ultra capacitors.

5. A device as in claim 1 wherein said first energy storage system comprises fuel cells.

6. A device as in claim 1 wherein said at least one other energy storage system stores energy in a form similar to said first energy storage system.

7. A device as in claim 1 wherein said at least one other energy storage system stores energy in a form different to said first energy storage system.

8. A device as in claim 2 wherein the potential energy of said gas under pressure is converted into electrical energy.

9. A device as in claim 8 wherein said electrical energy is produced via a turbine.

10. A device as in claim 8 wherein said electrical energy is produced via an oscillating chamber.

11. A device as in claim 8 wherein said electrical energy is produced without combustion.

12. A device as in claim 1 wherein said electric motor(s) are powered by energy supplied by a single energy storage system without requiring the use of energy from some other source.

13. A device as in claim 1 wherein said electric motor(s) are powered by energy supplied by at least two energy storage systems simultaneously.

14. A device as in claim 1 wherein energy from a first energy storage system is used to replenish the energy in at least one other energy storage system.

15. A device as in claim 1 wherein energy from a first energy storage system is used to increase the energy stored in at least one other energy storage system.

16. A device as in claim 14 wherein said replenishment is performed while the vehicle is in motion.

17. A device as in claim 15 wherein said increase is performed while the vehicle is in motion.

18. A device as in claim 1 wherein the energy in said first energy storage system is replenished or increased via connection to an energy source external to the vehicle while the vehicle is stationary.

19. A device as in claim 1 wherein the energy in said at least one other storage system is replenished or increased via connection to an energy source external to the vehicle while the vehicle is stationary.

20. A device as in claim 1 wherein excessive energy generated while the vehicle is in motion is stored in said first energy storage system.

21. A device as in claim 1 wherein excessive energy generated while the vehicle is in motion is stored in said at least one other energy storage system.
